(19) United States
(12) Patent Application Publication
(10) Pub. No.: US 2024/0032443 A1
(43) Pub. Date: Jan. 25, 2024

(54) Magnetic Memory Device Based on Perpendicular Exchange Bias and Method of Manufacturing Magnetic Memory Device

(71) Applicants: Hyundai Motor Company, Seoul (KR); Kia Corporation, Seoul (KR); Korea Advanced Institute of Science and Technology, Daejeon (KR)

(72) Inventors: Ji-Sung Lee, Daejeon (KR); Joon-Hyun Kwon, Seoul (KR); Su-Jung Noh, Seoul (KR); Han-Saem Lee, Seoul (KR); Dae-Kyu Koh, Daejeon (KR); Byong-Guk Park, Daejeon (KR); Jaimin Kang, Daejeon (KR); Soogil Lee, Daejeon (KR)

(21) Appl. No.: 18/154,986

(22) Filed: Jan. 16, 2023

(30) Foreign Application Priority Data
Jul. 20, 2022 (KR) 10-2022-0089341

(51) Int. Cl. H10N 52/80; H10N 52/85; H10N 52/01

(52) U.S. Cl. CPC H10N 52/80; H10N 52/85; H10N 52/01

(57) ABSTRACT

An embodiment magnetic memory device based on perpendicular exchange bias includes a non-magnetic layer, a ferromagnetic layer bonded on the non-magnetic layer, wherein a magnetization direction of the ferromagnetic layer is randomly distributed, and an anti-ferromagnetic layer bonded on the ferromagnetic layer. An embodiment method of manufacturing a magnetic memory device includes preparing the magnetic memory device based on perpendicular exchange bias, the preparing including bonding a ferromagnetic layer on a non-magnetic layer and bonding an anti-ferromagnetic layer on the ferromagnetic layer, and demagnetizing the ferromagnetic layer of the magnetic memory device, wherein a magnetization direction of the ferromagnetic layer is randomly distributed.

### CROSS-REFERENCE TO RELATED APPLICATIONS

This application claims the benefit of Korean Patent Application No. 10-2022-0089341, filed on Jul. 20, 2022, which application is hereby incorporated herein by reference.

### TECHNICAL FIELD

The present disclosure relates to a magnetic memory device based on a perpendicular exchange bias and a method of manufacturing the same.

### BACKGROUND

With the expansion of vehicle electronic components, the traveling of vehicles is being rapidly changed to an electronic drive-by-wire beyond a conventional mechanical operation, and thus a security issue of an electronic platform inside the vehicle is becoming an important issue.

Ahead of the mass production of autonomous vehicles according to the development of information and communication technologies such as Internet of Things (IoT), the security problem of an autonomous traveling system of the vehicle is emerging in a vehicle to everything (V2X) situation, and a failure to stably protect the autonomous traveling system from an external attack may cause a fatal threat to the lives of passengers or pedestrians.

In order to respond thereto, hardware-based security solutions beyond the stability of conventional software-based security solutions are recently starting to attract attention.

Embodiments of the present disclosure relate to a memory device that may be the key to the security problem.

FIGS. 1 to 3 show an example of a conventional physically unclonable function (PUF) memory device.

FIG. 1 shows a technique of securing randomness of an electrical contact by adjusting a via hole etching process for manufacturing a metal electrode in a semiconductor process to randomize a size of a via hole.

This secures uniqueness, randomness, and excellent repeatability that are not changed with environments (temperature, humidity, and the like). In addition, data encrypted with a VIA PUF key may not be decrypted without the VIA PUF key.

However, there is a limit in that reconfigurability is not secured.

FIG. 2 shows the implementation of the PUF using a phenomenon in which two magnetic tunnel junction elements are connected by one current line, a breakdown (BD) occurs in the elements by flowing an overcurrent therein, and then the BD randomly occurs in right and left magnetic tunnel junction (MTJ) elements, as a so-called spin transfer torque magnetic tunnel junction based physically unclonable function.

Since a BD portion is irreversible even in a next trial when BD occurs at one side, this is an ideal situation where the intra-die Hamming distance (HD) is 0%, and since BD randomly occurs anywhere, the intra-die HD is also high.

However, this also has a limit in that reconfigurability is not secured.

FIG. 3 shows the implementation of the PUF by etching an uppermost Ta (5 nm) capping layer to make a non-uniform thickness (0.6 to 0.8 nm) of MgO and thus adjusting the perpendicular magnetic anisotropy effect of a CoFeB/MgO interface that generates a perpendicular magnetization in a structure of Ta (10 nm)/CoFeB (1.6 nm)/MgO (1.6 nm)/Ta (5 nm), and reading a difference in anomalous Hall resistance values of each CoFeB when an external magnetic field is zero, as a so-called perpendicular magnetic anisotropy based physically unclonable function.

Although it is possible to secure the PUF characteristics that are not sensitive to the environments (temperature, radiation, and the like), a process and circuit for converting an anomalous Hall signal to a digital output are required separately, which also has a limit in that reconfigurability is not secured.

The matters described above in the above background art are intended to help the understanding of the background of embodiments of the disclosure, and may include matters that are not the related art already known to those skilled in the art to which this technology belongs.

The contents described in this section are to help the understanding of the background of embodiments of the present disclosure, and may include what is not previously known to those skilled in the art to which the present disclosure pertains.

### SUMMARY

Embodiments of the present disclosure can solve problems in the art, and embodiments of the present disclosure provide a magnetic memory device that has physically unclonable functions and reconfigurability using a magnetic memory device based on a perpendicular exchange bias, and a method of manufacturing the same.

A magnetic memory device based on a perpendicular exchange bias according to one embodiment of the present disclosure includes a non-magnetic layer, a ferromagnetic layer bonded on the non-magnetic layer, and an anti-ferromagnetic layer bonded on the ferromagnetic layer, wherein a magnetization direction of the ferromagnetic layer is randomly distributed.

In addition, the ferromagnetic layer is demagnetized.

In addition, the ferromagnetic layer has perpendicular anisotropy.

Here, the ferromagnetic layer is made of any one of CoFeB and CoFe alloy.

In addition, the non-magnetic layer is made of any one of Pt (platinum) and Ta (tantalum).

In addition, the anti-ferromagnetic layer is made of any one of IrMn and PtMn.

Next, a method of manufacturing a magnetic memory device based on perpendicular exchange bias according to one embodiment of the present disclosure includes preparing the magnetic memory device based on perpendicular exchange bias and demagnetizing the ferromagnetic layer of the magnetic memory device.

In addition, the demagnetizing of the ferromagnetic layer includes heating the magnetic memory device and applying a magnetic field to the magnetic memory device.

In addition, the heating of the magnetic memory device heats the magnetic memory device at a temperature of a Neel temperature or more of the ferromagnetic layer.

Furthermore, the applying of the magnetic field applies the magnetic field by alternately applying the magnetic field in a forward direction and a reverse direction to the magnetic memory device to sequentially reduce the magnetic field.

Embodiments of the present disclosure are based on the random magnetization pattern that is generated in a demagnetization process of a magnetic substance thin film and not controlled according to external factors.

Since the random magnetization arrangement formed by the method according to embodiments of the present disclosure does not have the same pattern at every attempt, when this is connected with the method of manufacturing the device using the physical and chemical methods and reading the magnetization direction (or characteristics relying on the magnetization direction) of each device using the electrical and optical methods, the device can be applied as the hardware-based security device.

In addition, the magnetization direction can be fixed by using the exchange magnetic coupling anisotropy in order to protect each magnetization pattern distributed randomly from the external impact such as a magnetic field or heat, and the device using the random magnetization pattern generated through the demagnetization of the thin film can be applied to applications connected with the MRAM device based on the magnetic tunnel junction that is being currently developed and the devices based on various magnetic substances in addition thereto.

### BRIEF DESCRIPTION OF THE DRAWINGS

FIGS. 1 to 3 show an example of a conventional magnetic memory device.

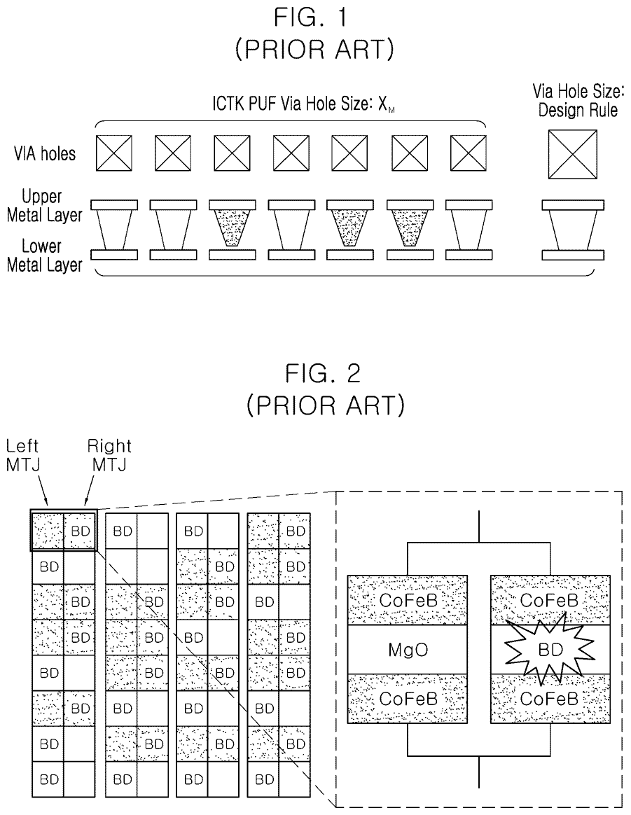

FIG. 4 schematically shows one example of a magnetic memory device according to embodiments of the present disclosure.

FIG. 5 shows a magnetization state before demagnetization.

FIG. 6 shows a change in a magnetic field due to the demagnetization according to embodiments of the present disclosure.

FIG. 7 shows an M-H curve according to a demagnetization process of a magnetic substance.

FIGS. 8 and 9 show a magnetic moment distribution after demagnetization.

FIG. 10 shows a result of confirming a random magnetization arrangement of a device array according to embodiments of the present disclosure by using a magneto-optic Kerr effect (MOKE), and FIG. 11 shows +Mz and −Mz states of the device.

FIGS. 12 and 13 show a hysteresis curve of the device array according to embodiments of the present disclosure.

FIG. 14 shows an anomalous Hall curve of a unit device.

### DETAILED DESCRIPTION OF ILLUSTRATIVE EMBODIMENTS

To fully understand embodiments of the present disclosure, operational advantages of embodiments of the present disclosure, and the objects achievable by practicing embodiments of the present disclosure, reference should be made to the accompanying drawings showing preferred embodiments of the present disclosure and the contents described in the accompanying drawings.

In describing preferred embodiments of the present disclosure, the description of well-known techniques or repetitive descriptions that may unnecessarily obscure the gist of the present disclosure will be reduced or omitted.

Among recent semiconductor devices, magnetic memory devices have ideal conditions as memory devices because they have a high speed, a low operating voltage, and non-volatile characteristics.

The magnetic memory device has a magnetic tunnel junction structure in which two ferromagnetic materials are separated by an insulating layer. Accordingly, information is stored as a magnetoresistance that varies depending on relative magnetization directions of two magnetic substances.

Magnetization directions of two magnetic layers may be controlled by a spin polarization current, which is called a spin transfer torque in which angular momentums of electrons are transferred to the magnetic moment to generate torque.

Embodiments of the present disclosure relate to a physically unclonable function (PUF) magnetic memory device so as to be usable in a security technology using the magnetoresistance characteristics.

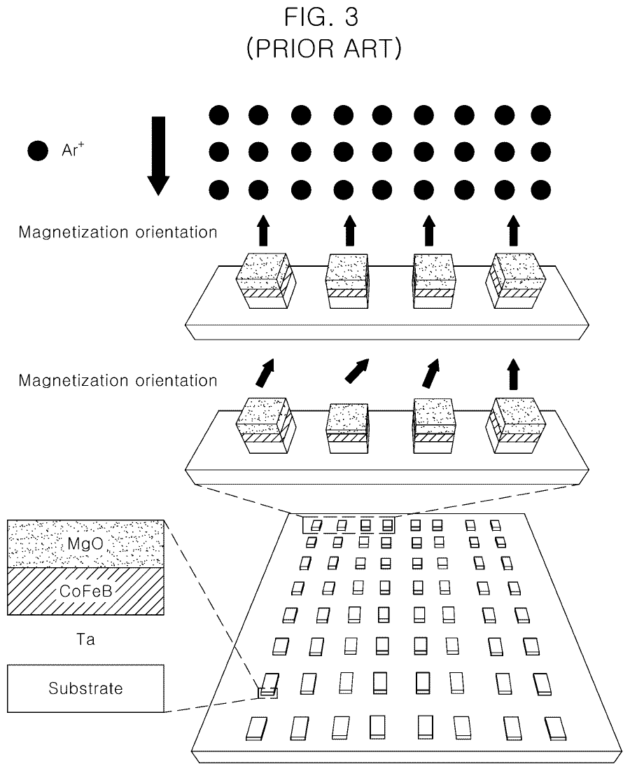

The magnetic memory device according to embodiments of the present disclosure includes a triple-layer structure of a non-magnetic layer 10, a ferromagnetic layer 20, and an anti-ferromagnetic layer 30, and FIG. 4 shows, for example, the non-magnetic layer 10 made of a Pt material, the ferromagnetic layer 20 made of a Co material, and the anti-ferromagnetic layer 30 made of an IrMn material.

The non-magnetic layer 10 may be a non-magnetic metal such as Pt (platinum) or Ta (tantalum), and the ferromagnetic layer 20 may be a ferromagnetic material made of a Co (cobalt) material such as CoFeB or CoFe alloy having perpendicular anisotropy.

In addition, the anti-ferromagnetic layer 30 may be IrMn, PtMn, or the like.

Accordingly, an exchange bias layer (Co/IrMn) is a randomness source and simultaneously functions as a detection layer.

Accordingly, it is possible to read an anomalous Hall resistance value of Co/IrMn by directly flowing a reading current.

In general, since a current density required to read the anomalous Hall resistance value is small, the power consumption required to operate the device may be much less.

Here, in embodiments of the present disclosure the magnetization direction of the ferromagnetic layer 20 having perpendicular anisotropy is randomly distributed.

In order to generate the distribution of the random magnetization directions, a final magnetic field may be zero by alternating the direction of an external magnetic field and applying the external magnetic field with reduced magnitude to a physically and chemically continuous magnetic thin film, and thus the magnetic thin film may be demagnetized.

In addition, in order to secure the external magnetic field and thermal stability of the ferromagnetic layer 20 having perpendicular anisotropy, it is possible to obtain randomness by applying the exchange magnetic bias anisotropy formed between the anti-ferromagnetic layer and the ferromagnetic layer by forming a structure in which the anti-ferromagnetic layer and the ferromagnetic layer are bonded.

Embodiments of the present disclosure can implement a device that reads the randomly distributed magnetization directions through an electrical or optical method according to the embodiment of the ferromagnetic layer 20 or the ferromagnetic layer 20 and the anti-ferromagnetic layer 30 instead of the ferromagnetic layer 20, which may be applied to various devices (MTJ-based MRAM devices and the like) including a physically unclonable function (PUF) security device.

The structure of the ferromagnetic layer 20 and the anti-ferromagnetic layer 30 makes it possible to secure stability against an external magnetic field.

Embodiments of the present disclosure heat a junction body at a temperature (a blocking temperature or a Neel temperature) or more at which the exchange magnetic bias anisotropy between the anti-ferromagnetic layer 30 and the ferromagnetic layer 20 disappears in the above-described triple-layer structure, and forms the random magnetization arrangement of the perpendicular magnetization ferromagnetic layer by performing the demagnetization process that alternately applies the magnetic field at the blocking temperature or higher. Alternatively, the ferromagnetic layer may be demagnetized by ion irradiation.

Accordingly, a random distribution of the exchange magnetic bias anisotropy following the random magnetization arrangement of the horizontally magnetized ferromagnetic layer is secured by cooling the junction body to the blocking temperature or less.

Hereinafter, the random magnetization arrangement is confirmed by using the magneto-optic Kerr effect (MOKE) by performing the demagnetization process by the structure of the ferromagnetic layer and an anti-ferromagnetic layer to form the random magnetization arrangement.

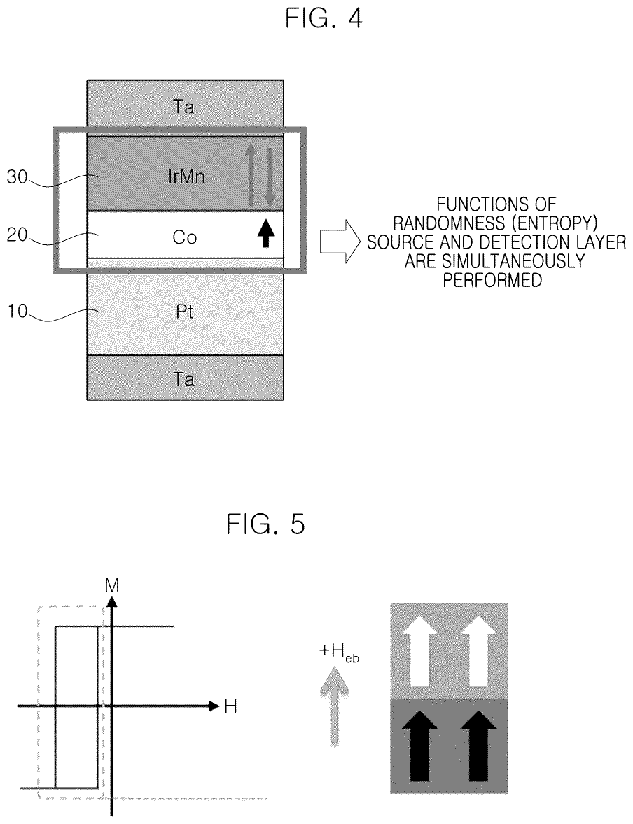

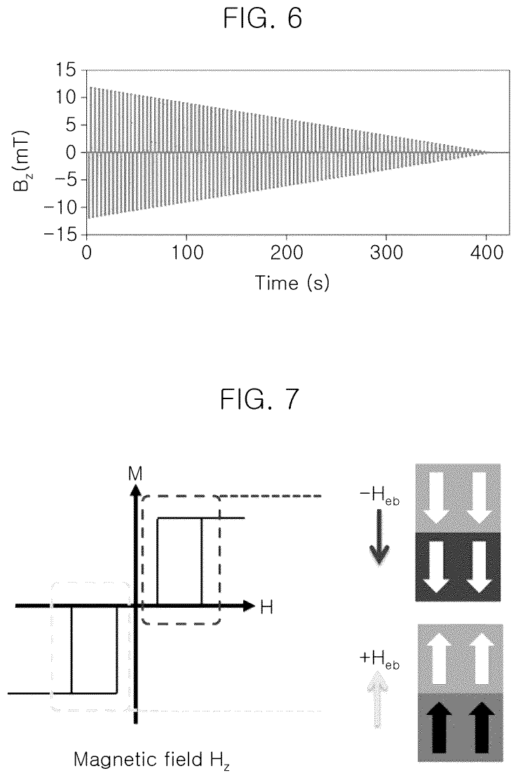

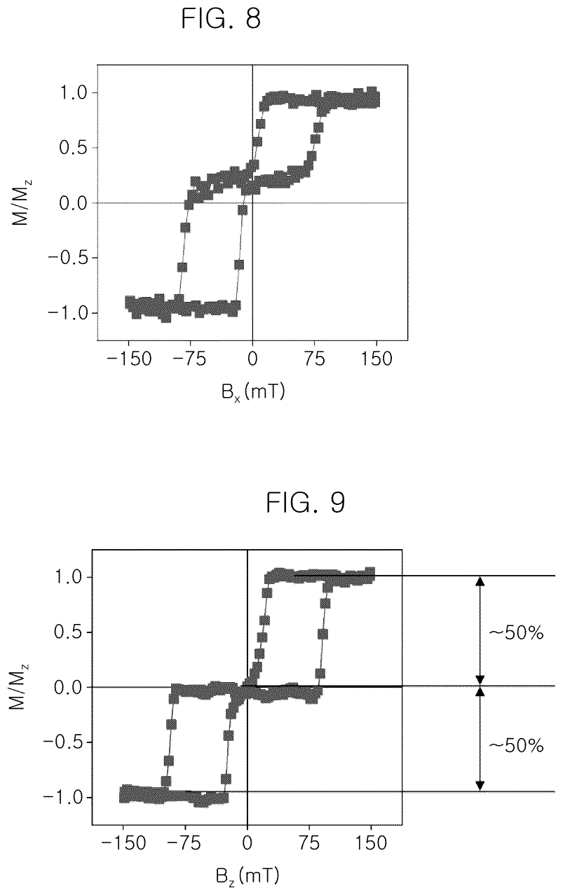

The ferromagnetic layer 20 before demagnetization has a magnetization state as shown in FIG. 5, and the random distribution of the perpendicular magnetization is generated as shown in the M-H curve in FIG. 7 by the above-described demagnetization process as shown in FIG. 6.

FIG. 7 shows the M-H curve by the demagnetization process of the magnetic substance, and a magnetic memory device may be manufactured by using this sample and used as a PUF device.

First, in order to demagnetize the double-layer structure of the anti-ferromagnetic layer and the ferromagnetic layer, 1) the holder supporting the sample is heated at the blocking temperature or more of the anti-ferromagnetic layer, 2) the sample is heated in the holder for 30 seconds, and 3) the demagnetization process is performed for 30 seconds.

The blocking temperature of the anti-ferromagnetic layer is, for example, 240° C., and the demagnetization process is performed until the magnetic field becomes zero by alternating the direction of the magnetic field in a forward direction and a reverse direction to sequentially reduce the magnetic field.

Next, after cooling the sample, the sample is measured through a vibrating sample magnetometer (VSM).

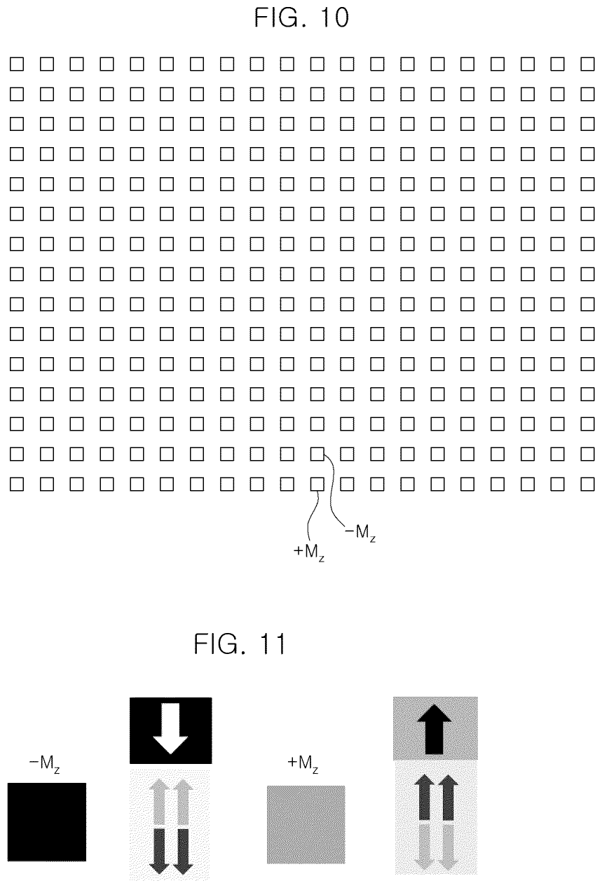

As a result, in the magnetic moment state before demagnetization with respect to the easy axis (as-deposited) in FIG. 8, the distribution is shown as in FIG. 9 after demagnetization. As shown, a 5:5 ratio does not appear in the as-deposited state, but it can be confirmed that a ratio of up and down of the magnetic domain may be divided into 5:5 through the demagnetization process.

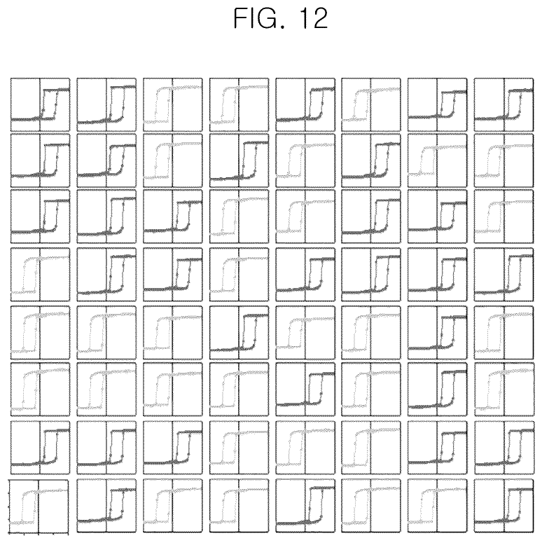

Next, FIG. 10 shows a result of capturing a MOKE image by configuring the above-described device structure according to embodiments of the present disclosure in a 20×15 array pattern, and the random distribution of the magnetic domain could be confirmed.

The +Mz and −Mz states of each device are shown in FIG. 11, and it could be confirmed that a ratio of +Mz and −Mz was 154:146 (51%:49%) and excellent uniformity was secured.

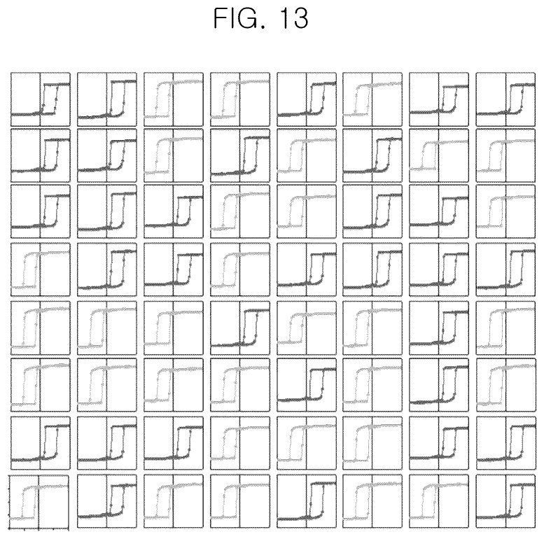

In addition, FIG. 12 shows a result of measuring the anomalous Hall effect (AHE) after a first demagnetization by manufacturing an 8×8 array, and a pattern result of 32:32 was derived.

By measuring a hysteresis loop shift through the AHE, the direction of the perpendicular exchange bias can be known, which means that electrical measurements are possible.

FIG. 13 shows a result of measuring the anomalous Hall effect after a second demagnetization.

Upon the second demagnetization for the same PUF, different patterns of 33:31 were acquired, which means that the manufactured PUF device has reconfigurability.

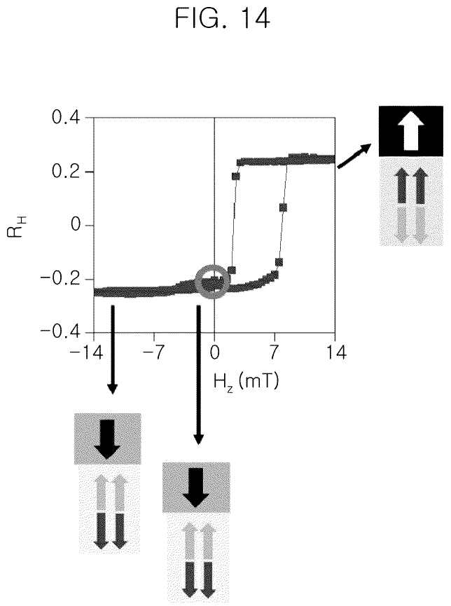

Additionally, referring to FIG. 14, when the anomalous Hall curve of the unit device is viewed, it can be seen that there is one magnetic state in the zero field.

This means that a direction of a ferromagnet is fixed in a down state as shown in both a case in which an external magnetic field is applied as + and then removed and a case in which the external magnetic field is applied as − and then removed.

Accordingly, it means that the magnetization direction of the ferromagnet is not changed by the exchange bias and a bit of the output PUF is not changed even when the external magnetic field is applied and then removed.

Accordingly, in the perpendicular PUF device, it can be seen that the PUF pattern is not changed even when the external magnetic field is applied and then removed.

As described above, according to the structure of the magnetic memory device according to embodiments of the present disclosure, the random magnetization distribution is randomly arranged so that the magnetization distribution is not the same each time the magnetization distribution attempts to be formed by using the same method, and the randomness has a property that may not be intentionally controlled due to external process factors.

Accordingly, based on the characteristics, the spintronic PUF device based on perpendicular exchange bias using the random magnetization direction distribution according to embodiments of the present disclosure has reconfigurability.

As described above, embodiments of the present disclosure have been described with reference to the exemplary drawings, but the present disclosure is not limited to the described embodiments, and it is apparent to those skilled in the art that the present disclosure may be variously modified and changed without departing from the spirit and scope of the present disclosure. Accordingly, the modified examples or changed examples should belong to the claims of the present disclosure, and the scope of the present disclosure should be construed based on the appended claims.

What is claimed is:

1. A magnetic memory device based on perpendicular exchange bias, the magnetic memory device comprising:
a non-magnetic layer;
a ferromagnetic layer bonded on the non-magnetic layer, wherein a magnetization direction of the ferromagnetic layer is randomly distributed; and
an anti-ferromagnetic layer bonded on the ferromagnetic layer.

2. The magnetic memory device of claim 1, wherein the ferromagnetic layer is demagnetized.

3. The magnetic memory device of claim 2, wherein the ferromagnetic layer has perpendicular anisotropy.

4. The magnetic memory device of claim 3, wherein the ferromagnetic layer comprises CoFeB or a CoFe alloy.

5. The magnetic memory device of claim 4, wherein the non-magnetic layer comprises Pt or Ta.

6. The magnetic memory device of claim 5, wherein the anti-ferromagnetic layer comprises IrMn or PtMn.

7. The magnetic memory device of claim 1, wherein the ferromagnetic layer comprises CoFeB or a CoFe alloy.

8. The magnetic memory device of claim 1, wherein the non-magnetic layer comprises Pt or Ta.

9. The magnetic memory device of claim 1, wherein the anti-ferromagnetic layer comprises IrMn or PtMn.

10. A method of manufacturing a magnetic memory device, the method comprising:
preparing the magnetic memory device based on perpendicular exchange bias by bonding a ferromagnetic layer on a non-magnetic layer and bonding an anti-ferromagnetic layer on the ferromagnetic layer; and
demagnetizing the ferromagnetic layer of the magnetic memory device, wherein a magnetization direction of the ferromagnetic layer is randomly distributed.

11. The method of claim 10, wherein demagnetizing the ferromagnetic layer comprises:
heating the magnetic memory device; and
applying a magnetic field to the magnetic memory device.

12. The method of claim 11, wherein heating the magnetic memory device comprises heating the magnetic memory device at a temperature of a Neel temperature of the ferromagnetic layer or higher.

13. The method of claim 12, wherein applying the magnetic field comprises applying the magnetic field by alternately applying the magnetic field in a forward direction and a reverse direction to the magnetic memory device to sequentially reduce the magnetic field.

14. The method of claim 10, wherein the ferromagnetic layer has perpendicular anisotropy.

15. The method of claim 10, wherein the ferromagnetic layer comprises CoFeB or a CoFe alloy.

16. The method of claim 10, wherein the non-magnetic layer comprises Pt or Ta.

17. The method of claim 10, wherein the anti-ferromagnetic layer comprises IrMn or PtMn.

18. A method of manufacturing a magnetic memory device based on perpendicular exchange bias, the method comprising:
bonding a ferromagnetic layer comprising Co on a non-magnetic layer;
bonding an anti-ferromagnetic layer on the ferromagnetic layer;
heating the magnetic memory device at a temperature of a Neel temperature of the ferromagnetic layer or higher; and
applying a magnetic field to the magnetic memory device to demagnetize the ferromagnetic layer, wherein a magnetization direction of the ferromagnetic layer is randomly distributed.

19. The method of claim 18, wherein applying the magnetic field comprises applying the magnetic field by alternately applying the magnetic field in a forward direction and a reverse direction to the magnetic memory device to sequentially reduce the magnetic field.

20. The method of claim 18, wherein:
the ferromagnetic layer comprises CoFeB or a CoFe alloy;
the non-magnetic layer comprises Pt or Ta; and
the anti-ferromagnetic layer comprises IrMn or PtMn.
